(19) United States
(12) Patent Application Publication
(10) Pub. No.: US 2010/0003074 A1
(43) Pub. Date: Jan. 7, 2010

(54) CONNECTING STRUCTURE OF STEEL BAR

(75) Inventor: Kwang Man Kim, Seoul (KR)

Correspondence Address: SHERIDAN ROSS PC, 1560 BROADWAY, SUITE 1200, DENVER, CO, 80202, US

(73) Assignee: BARO CONSTRUCTION KEY-TECHNOLOGY CO., LTD., Seoul (KR)

(21) Appl. No.: 12/517,756

(22) PCT Filed: Dec. 21, 2007
(86) PCT No.: PCT/KR2007/006722

§ 371 Date: Aug. 31, 2009

(30) Foreign Application Priority Data
Dec. 21, 2006 (KR) 10-2006-0132248

(51) Int. Cl. F16B 7/02; F16B 7/18; F16B 2/14; F16D 1/00

(52) U.S. Cl. 403/334; 403/296; 403/374.4; 403/8

(57) ABSTRACT

A steel bar connecting structure is disclosed. The steel bar connecting structure includes a connecting sleeve having on an inner circumference thereof an internal threaded part, and a steel bar having an external threaded part which engages with the internal threaded part. The steel bar is inserted into the connecting sleeve. Each of the internal threaded part and the external threaded part is formed such that a crest of each of threads thereof is cut. Thereby, when the steel bar is strongly coupled to the connecting sleeve, a neighboring crest and root of the internal threaded part and the external threaded part are not in contact with each other, whereas inclined flanks of the threads of the internal threaded part and the external threaded part are in close contact with each other.

### TECHNICAL FIELD

The present invention relates to a steel bar connecting structure. More particularly, the present invention relates to a steel bar connecting structure, in which external threaded parts and slits are provided on the outer circumference of a connecting sleeve, and the slits become narrow and inclined flanks of external threads of steel bars come into close contact with inclined flanks of internal threads provided on the inner circumference of the connecting sleeve when the steel bars are inserted into the connecting sleeve and then nuts are fastened to the external threaded parts provided on the outer circumference of the connecting sleeve.

### BACKGROUND ART

FIG. 1 is a sectional view showing one conventional bar connector using a bolt and nut fastening method.

As shown in FIG. 1, the bar connector includes steel bars 92 each having on an end thereof an external threaded part 94, and a nut 90 having an internal threaded part 91 on the inner circumference of the nut into which each steel bar 92 is inserted.

The external threaded part 94 is formed such that the depth of roots is reduced in a direction moving away from an end 93 of each steel bar 92. Conversely, the internal threaded part 91 is formed such that the shape of threads is constant.

Thus, when each steel bar 92 is inserted into the nut 90 in the state of FIG. 1a, a thread of the external threaded part 94, which is provided on the end 93 of the steel bar 92, is easily engaged with the internal threaded part 91 of the nut 90. However, roots of the external threaded part 94, which are spaced apart from the end 93 of the steel bar 92 by a predetermined distance, are tightened by threads of the internal threaded part 91 of the nut 90. Thereby, each steel bar 92 is fastened to the nut 90.

FIG. 2 is a view illustrating another conventional steel bar connector in an exploded perspective view and a sectional view, and FIG. 3 is a sectional view showing the steel bar connector of FIG. 2, in which steel bars are connected to each other via the steel bar connector.

Referring to FIG. 2, the steel bar connector includes a cylindrical connecting sleeve 1, steel bars 5 which are inserted into the connecting sleeve 1, and nuts 10 which tighten the connecting sleeve 1 into which the steel bars 5 are inserted.

The connecting sleeve 1 includes a first internal threaded part 4, inclined parts 3, first external threaded parts 16, and a plurality of slits 15. The first internal threaded part 4 is formed on a predetermined portion of the inner circumference of the connecting sleeve. The inclined parts 3 are inclined in such a way that their outer diameters are reduced towards opposite ends of the connecting sleeve. The first external threaded parts 16 are provided on the inclined parts 3. The slits 15 are provided in the longitudinal direction of the connecting sleeve 1.

Further, each steel bar 5 includes a second external threaded part 7, which is provided on the outer circumference of an end of the steel bar, and projecting ribs 8, which are provided behind the second external threaded part 7.

A second internal threaded part 12 is provided in each nut 10, and engages with the corresponding first external threaded part 16.

The conventional steel bar connector, which is constructed as described above, is operated as follows.

In the state where respective elements of the steel bar connector are separated from each other, as shown in FIG. 2, each steel bar 5 is inserted into the connecting sleeve 1. At this time, as shown in FIG. 3, the second external threaded part 7 engages with the first internal threaded part 4. In this state, when each nut 10 is fitted over the connecting sleeve 1, the projecting ribs 8 of the steel bar are in friction contact with an inner wall 17 which is provided outside the first internal threaded part 4.

However, these conventional bar connectors have the following problems.

A connecting structure using internal and external threads must have two functions, that is, fastening and tightening functions. The fastening operation is possible when there is a gap between the internal and external threads. The tightening operation is achieved using additional means.

The tightening method of the first conventional bar connector is as follows. That is, the root, which is provided at an end of the external threaded part 94, is formed to be low, so that the crest of the internal threaded part 91 is in close contact with the root of the external threaded part 94. Thereby, the connector is tightened.

However, the tightening method is problematic in that only a portion of the external threaded part is in close contact with the internal threaded part, and a gap exists between the remaining portion of the external threaded part and the internal threaded part, so that the contact portions may slip slightly relative to each other in the event of a momentary strong impact, such as seismic load or wind load, and thereby deformation may occur.

Generally, the bar connector is used together with concrete, so that the concrete and the steel bars share a load. However, because of small deformation in the connector, the load that should be borne by the steel bars may be transferred to the concrete. In this case, the concrete is unable to bear the load, and a structure may consequently be destroyed.

The second conventional bar connector also has fastening and tightening structures. The threaded parts themselves have gaps. Further, the surface of each steel bar is in close contact with the surface of the associated threaded part of the connecting sleeve, so that the connector is tightened. However, when a load that is larger than surface frictional force is generated, the contact portions may slip relative to each other, and deformation may occur due to the gaps between the threaded parts, as in the first conventional bar connector.

### DISCLOSURE OF INVENTION

### Technical Problem

Accordingly, the present invention has been made keeping in mind the above problems occurring in the prior art, and an object of the present invention is to provide a steel bar connecting structure, which performs a fastening method using a connecting sleeve that is larger than a steel bar, and which performs a tightening method using longitudinal slits which are formed along the connecting sleeve and a nut which is fastened to the outer circumference of the connecting sleeve so as to close the slits, and in which threaded parts of the connecting sleeve and the steel bar engage with each other in such a way that crests and roots of the threaded parts of the connecting sleeve and the steel bar are not in contact with each other in longitudinal directions, but inclined flanks of the threaded parts of the connecting sleeve and the steel bar are in strong close contact with each other, thus preventing slippage in a longitudinal direction, therefore preventing deformation due to momentary large impacts, such as seismic load or wind load.

### Technical Solution

In order to accomplish the above object, the present invention provides a steel bar connecting structure, including a connecting sleeve having on an inner circumference thereof an internal threaded part, and a steel bar having an external threaded part which engages with the internal threaded part, the steel bar being inserted into the connecting sleeve, wherein each of the internal threaded part and the external threaded part is formed such that a crest of each of threads thereof is cut, whereby when the steel bar is strongly coupled to the connecting sleeve, a neighboring crest and root of the internal threaded part and the external threaded part are not in contact with each other, whereas inclined flanks of the threads of the internal threaded part and the external threaded part are in close contact with each other.

Further, the present invention provides a steel bar connecting structure including a connecting sleeve which has a cylindrical shape, and has on an inner circumference thereof a first internal threaded part, and is inclined such that an outer diameter of the connecting sleeve is reduced from a center thereof to opposite ends thereof, with first external threaded parts provided on inclined parts of an outer circumference of the connecting sleeve, and a plurality of slits provided in the opposite ends of the connecting sleeve and extending in a longitudinal direction of the connecting sleeve, two nuts fastened to the first external threaded parts, respectively, and a steel bar having on an outer circumference thereof a second external threaded part, which engages with the first internal threaded part, wherein a circumference of the second external threaded part of the steel bar is smaller than a circumference of the first internal threaded part provided on an inner circumference of the connecting sleeve so that the second external threaded part is not in complete contact with the first internal threaded part, and a crest of each of threads of the first internal threaded part and the second external threaded part is cut, whereby when the steel bar is inserted into the connecting sleeve and each of the nuts is fastened to each of the first external threaded parts provided on the outer circumference of the connecting sleeve, so that the slits become narrow and the steel bar is strongly coupled to the connecting sleeve, a neighboring crest and root of the threads of the internal threaded part and the external threaded part are not in contact with each other, and inclined flanks of the threads of the internal threaded part and the external threaded part are in close contact with each other.

The slits may comprise four or more slits arranged radially, and an observation hole may be provided at a predetermined position in the flat part.

The slits are alternately arranged on the opposite ends of the connecting sleeve, and extend from the opposite ends of the connecting sleeve through a center thereof to predetermined positions. Part of a thread, positioned at an end of the steel bar, is eliminated to a depth of a root, and a first end surface is provided on an end thread among the remaining threads. Further, roots of some threads in the connecting sleeve are filled to a height of thread. A second end surface provided at the center of the filling part is provided to be parallel to a longitudinal direction of the connecting sleeve. Thus, when each steel bar is inserted into the connecting sleeve, so that the first end surface comes into contact with the second end surface, the steel bar does not move into the connecting sleeve any further.

Meanwhile, the present invention provides a steel bar connecting structure, including a connecting sleeve having on an inner circumference thereof first concave parts and first convex parts at regular intervals in such a way as to be perpendicular to a longitudinal direction of the connecting sleeve, and a steel bar inserted into the connecting sleeve, and having second concave parts and second convex parts in such a way as to be perpendicular to a longitudinal direction of the steel bar, the second concave parts and the second convex parts being coupled to the first concave parts and the first convex parts, wherein each of the first convex parts of the connecting sleeve is not higher than a corresponding first concave part of the steel bar, and each of the first concave parts of the connecting sleeve is higher than a corresponding second convex part of the steel bar, so that when the steel bar is coupled to the connecting sleeve, apexes of the convex and concave parts of the connecting sleeve and the steel bar are in contact with each other, and inclined side surfaces of the concave and convex parts are in strong close contact with each other, when the steel bar is coupled to the connecting sleeve.

Further, the present invention provides a steel bar connecting structure, including a connecting sleeve comprising a plurality of parts which are divided in a longitudinal direction of the connecting sleeve and are assembled with each other, thus forming a cylindrical shape, an outer circumference of the connecting sleeve being inclined such that a thickness thereof is reduced from a center of the connecting sleeve to opposite ends thereof, with first external threaded parts provided on the outer circumference of the connecting sleeve, the connecting sleeve having on an inner circumference thereof first concave parts and first convex parts at regular intervals in such a way as to be perpendicular to the longitudinal direction of the connecting sleeve, two nuts fastened to the first external threaded parts, respectively, and steel bars each having on an outer circumference thereof second concave parts and second convex parts in such a way as to be perpendicular to a longitudinal direction of the steel bar, the second concave parts and the second convex parts being coupled to the first concave parts and the first convex parts, wherein when the divided parts of the connecting sleeve are positioned between the two steel bars, and the nuts are fastened to first external threaded parts, which are provided on inclined parts of the opposite ends of the connecting sleeve, the divided parts of the connecting sleeve are brought near to each other, and an inner diameter of the connecting sleeve is reduced, and since each of the first convex parts of the connecting sleeve is not higher than a corresponding first concave part of each of the steel bars, and each of the first concave parts of the connecting sleeve is higher than a corresponding second convex part of the steel bar, apexes of the concave and convex parts of the connecting sleeve and each of the steel bars are not in contact with each other, and inclined side surfaces of the concave and convex parts are in close contact with each other, when the steel bar is coupled to the connecting sleeve.

Further, a stop protrusion protrudes inwards from an inner circumference of each of the divided parts of the connecting sleeve, so that when the two steel bars are inserted into the connecting sleeve, the steel bars do not pass through the center of the connecting sleeve.

### BRIEF DESCRIPTION OF THE DRAWINGS

FIG. 1 is a sectional view showing one conventional bar connector using a bolt and nut fastening method;

FIG. 2 a view illustrating another conventional steel bar connector in an exploded perspective view and a sectional view;

FIG. 3 is a sectional view showing the steel bar connector of FIG. 2, in which steel bars are connected to each other via the steel bar connector;

FIG. 4 is an exploded perspective view showing a steel bar connecting structure, according to the first embodiment of the present invention;

FIG. 5 is a sectional view showing the steel bar connecting structure of FIG. 4;

FIG. 6 is a sectional view showing the steel bar connecting structure of FIG. 5, in which steel bars are coupled to each other using the steel bar connecting structure;

FIG. 7 is an enlarged view showing important parts of FIG. 5;

FIG. 8 is an enlarged view showing portion B, circled in FIG. 6;

FIG. 9 is an exploded perspective view showing a steel bar connecting structure, according to the second embodiment of the present invention; and

FIG. 10 is a perspective view showing a steel bar connecting structure, according to the third embodiment of the present invention.

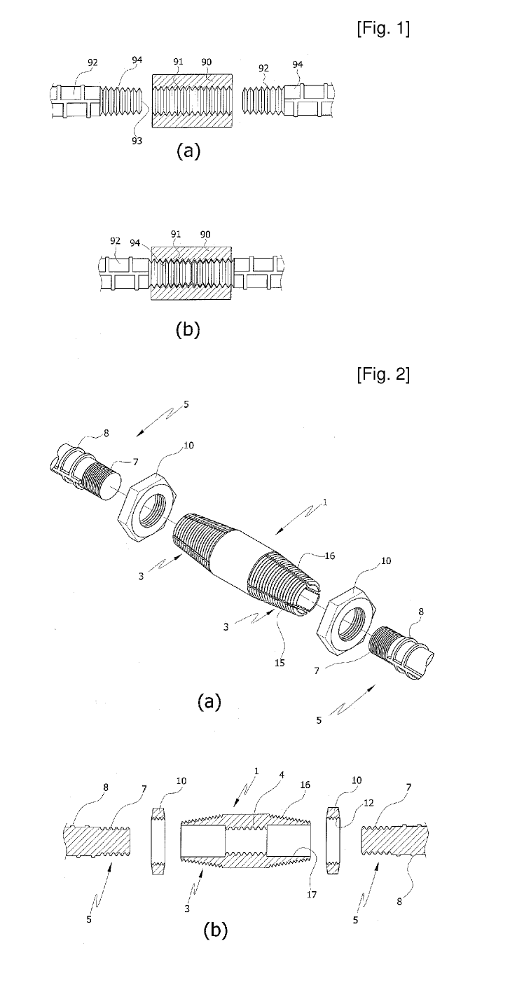

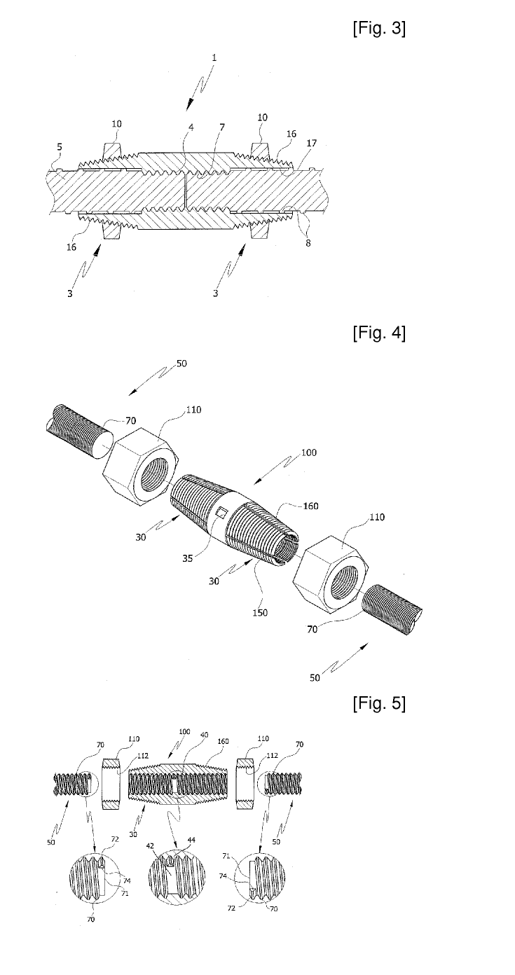

### DESCRIPTION OF REFERENCE CHARACTERS OF IMPORTANT PARTS

30: inclined part 40: internal threaded part

50: steel bar 70: external threaded part

100: connecting sleeve 110: nut

### BEST MODE FOR CARRYING OUT THE INVENTION

Reference should now be made to the drawings, in which the same reference numerals are used throughout the different drawings to designate the same or similar components. For the clarity of description, detailed descriptions of known constructions and functions will be omitted herein.

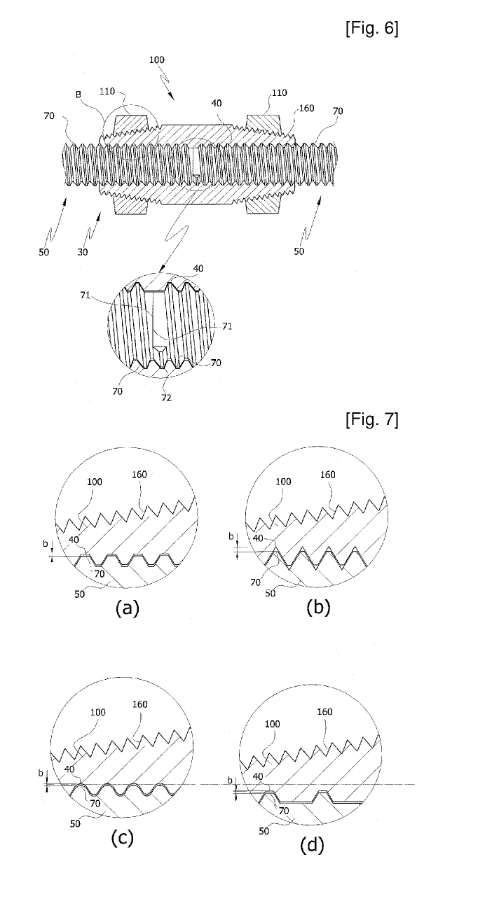

FIG. 4 is an exploded perspective view showing a steel bar connecting structure, according to the first embodiment of the present invention, FIG. 5 is a sectional view showing the steel bar connecting structure of FIG. 4, and FIG. 6 is a sectional view showing the steel bar connecting structure of FIG. 5, in which steel bars are coupled to each other using the steel bar connecting structure.

According to the first embodiment of the present invention, the steel bar connecting structure includes a connecting sleeve 100, nuts 110, and steel bars 50.

In a detailed description, the connecting sleeve 100 has a cylindrical shape. A first internal threaded part 40 is provided in the inner circumference of the connecting sleeve 100. The outer circumference of the connecting sleeve is shaped such that its outer diameter is reduced from the center of the connecting sleeve to opposite ends thereof, thus forming inclined parts 30. First external threaded parts 160 are formed on the inclined parts 30. A plurality of slits 150 is provided on both ends of the connecting sleeve in a longitudinal direction thereof.

Further, a second internal threaded part 112 is obliquely formed in the inner circumference of each nut 110, and engages with the corresponding first external threaded part 160 provided on the outer circumference of the connecting sleeve 100.

The circumference of a second external threaded part 70 of each steel bar 50 is formed to be smaller than the circumference of the first internal threaded part 40 provided in the inner circumference of the connecting sleeve 100, and thus the steel bar is not in complete contact with the connecting sleeve. The crest of each thread of the first internal threaded part 40 and the second external threaded part 70 is cut.

Each steel bar 50 has on the outer circumference thereof the second external threaded part 70, which engages with the first internal threaded part 40.

Part of thread, positioned at the end 71 of each steel bar 50, is eliminated to the depth of the root thereof. A first end surface 74 is provided on an end thread 72 among the remaining threads. A filling part 42, having no root, is provided in the central portion of the connecting sleeve 100. A second end surface 44 is provided on an end of the filling part 42. When each steel bar 50 is inserted into the connecting sleeve 100, so that the first end surface 74 comes into contact with the second end surface 44, the steel bar 50 does not move into the connecting sleeve 100 any further.

Therefore, both steel bars 50 are in close contact with each other precisely at the center in the connecting sleeve 100.

The first external threaded parts 160 and the slits 150, which are provided on the outer circumference of the connecting sleeve 100, extend from the opposite ends of the connecting sleeve to a flat part 37 which is provided at the central portion of the connecting sleeve.

Further, the slits 150 comprise four slits which are radially provided on each inclined part. An observation hole 35 is provided at a predetermined position in the flat part 37, provided at the central portion of the connecting sleeve 100.

The operation of the steel bar connecting structure, according to the present invention, which is constructed as described above, is as follows.

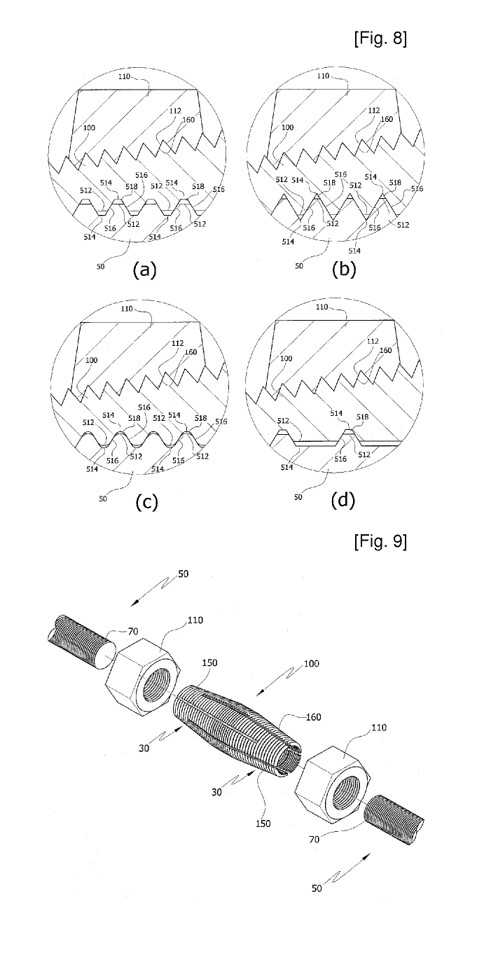

FIG. 7 is an enlarged view showing important parts of FIG. 5, and FIG. 8 is an enlarged view showing portion B, circled in FIG. 6.

In the state where the connecting sleeve 100, the nuts 110, and the steel bars 50 are separated from each other, as shown in FIG. 5, the steel bars 50 are inserted into the connecting sleeve 100. Afterwards, the nuts 110 are fastened to the first external threaded parts 160, provided on the outer circumference of the connecting sleeve 100. Thereby, the connecting sleeve, the nuts, and the steel bars are connected to each other, as shown in FIG. 6.

FIG. 7 shows the state in which each nut 110 of FIG. 5 is not fastened to the connecting sleeve 100, and each steel bar 50 is inserted into the connecting sleeve 100. An interval b is defined between the second external threaded part 70 and the first internal threaded part 40.

The threads of the second external threaded part 70 and the first internal threaded part 40 have various shapes, as shown in FIGS. 7a to 7d.

When each nut 110 is fastened to the corresponding first external threaded part 160, provided on the outer circumference of the connecting sleeve 100 in the state of FIG. 7, the coupling state of FIG. 6 is achieved. Meanwhile, when each nut 110 is moved towards the center of the connecting sleeve 100, the second internal threaded part 112 engages with the corresponding first external threaded part 160. At this time, each slit 150 of FIG. 4 becomes narrow, so that each steel bar 50 is firmly coupled to the connecting sleeve 100. In this case, a neighboring crest 512 and root 514 of the first internal threaded part 40 and the second external threaded part 70 are not in contact with each other, whereas inclined flanks 516 of threads of the first internal threaded part 40 and the second external threaded part 70 are in close contact with each other.

Further, when each nut 110 continues to move to the center of the connecting sleeve 100 while a worker observes the engagement between the second external threaded part 70 and the first internal threaded part 40 through the observation hole 35, a first space 518, which is defined between a neighboring crest and root of the second external threaded part 70 and the first internal threaded part 40, becomes narrow. Thereby, the neighboring inclined flanks 516 of the second external threaded part 70 and the first internal threaded part 40 are brought into closer contact with each other.

FIGS. 8a to 8d show various contact shapes of the second external threaded part 70 and the first internal threaded part 40, according to the shapes of threads.

Even if impurities are present in the first space 518, they do not affect the engagement of the second external threaded part 70 with the first internal threaded part 40. Further, hardly any impurities remain on the inclined flanks 516. Even if impurities remain on the inclined flanks 516, the impurities move to the first space 518 while the second external threaded part 70 engages with the first internal threaded part 40.

Therefore, the steel bar connecting structure, according to the present invention, provides a firmer connection than in the case where the second external threaded part 70 precisely engages with the first internal threaded part 40, and maintains a strong coupling force against strong vibrations or impacts, such as earthquakes.

FIG. 9 is an exploded perspective view showing a steel bar connecting structure according to the second embodiment of the present invention.

The slits 150 are alternately arranged on opposite ends of the connecting sleeve 100, and extend from the opposite ends of the connecting sleeve 100 through the central position to predetermined positions.

In the steel bar connecting structure of FIG. 9, the slits 150 are alternately arranged on the opposite ends of the connecting sleeve 100, and do not meet each other at the center of the connecting sleeve 100. Thus, the inclined part 30 may extend from each of the opposite ends of the connecting sleeve 100 to the center thereof. Thereby, the inclined part 30 is formed at a gentler incline.

Therefore, when each nut 110 is fastened to the connecting sleeve 100, the nut 110 can be fastened more deeply towards the center of the connecting sleeve 100. Each second external threaded part 70 engages slowly with the first internal threaded part 40 over a larger range. Consequently, the contact areas of neighboring inclined flanks 516 between the second external threaded part 70 and the first internal threaded part 40 are increased, so that the steel bar is brought into closer contact with the connecting sleeve.

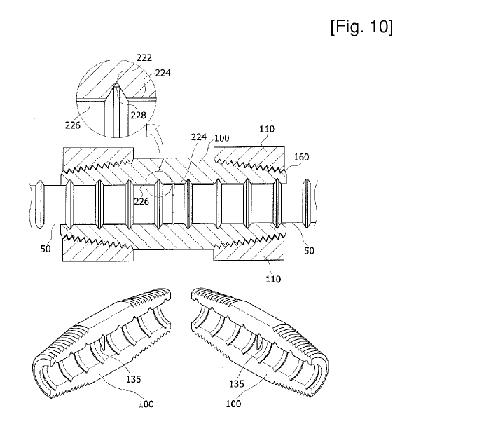

Meanwhile, the present invention provides a steel bar connecting structure, in which connecting parts of the connecting sleeve and the steel bar are not threaded parts, but are concave and convex parts. FIG. 10 is a perspective view showing a steel bar connecting structure according to the third embodiment of the present invention.

As shown in FIG. 10, the steel bar connecting structure of the present invention includes a connecting sleeve 100, two nuts 110, and steel bars 50. The connecting sleeve is divided into a plurality of longitudinal parts. The longitudinal parts are assembled with each other, thus providing the cylindrical connecting sleeve. The connecting sleeve is inclined such that its thickness is reduced from the center to opposite ends thereof. First external threaded parts 160 are provided on the inclined parts of the connecting sleeve. First concave parts 222 and first convex parts 224 are provided in the connecting sleeve 100 at regular intervals in such a way as to be perpendicular to the longitudinal direction of the connecting sleeve. The nuts 110 engage with the corresponding first external threaded parts 160. Second concave parts 226 and second convex parts 228 are provided on the outer circumference of each steel bar 50 in such a way as to be perpendicular to the longitudinal direction of the steel bar, and are coupled to the first convex parts 224 and the first concave parts 222.

Further, the divided parts of the connecting sleeve 100 are positioned between the two steel bars 50, and the nuts 110 are placed on the inclined ends of the connecting sleeve 100 to be fastened to the corresponding first external threaded parts 160. At this time, the divided parts of the connecting sleeve 100 are brought near to each other, so that the inner diameter of the connecting sleeve 100 is reduced. Each first convex part 224 of the connecting sleeve 100 is not higher than the corresponding first concave part 222 of each steel bar 50. Meanwhile, each first concave part 222 of the connecting sleeve 100 is higher than the corresponding second convex part 228 of each steel bar 50. Thus, when each steel bar 50 is coupled to the connecting sleeve 100, apexes of the concave and convex parts of the connecting sleeve 100 and the steel bars 50 are not in contact with each other, and inclined side surfaces of the concave and convex parts are in close contact with each other.

Each divided part of the connecting sleeve 100 has on its inner circumference a stop protrusion 135, which protrudes inwards. Thus, when the two steel bars 50 are inserted into the connecting sleeve 100, the stop protrusion prevents each steel bar 50 from passing through the center of the connecting sleeve 100.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a steel bar connecting structure, in which when a nut is fitted over a connecting sleeve and is tightened, slits become narrow, and the coupling force between an external threaded part, provided on the outer circumference of a steel bar, and an internal threaded part, provided on the inner circumference of the connecting sleeve, is considerably increased, thus achieving a structure capable of withstanding a large seismic load or wind load, therefore allowing a high-rise building to be safely built.

1. A steel bar connecting structure, comprising:
a connecting sleeve having on an inner circumference thereof a first internal threaded part; and
a steel bar having a second external threaded part which engages with the first internal threaded part, the steel bar being inserted into the connecting sleeve, wherein
each of the first internal threaded part and the second external threaded part is formed such that a crest of each of threads thereof is cut, whereby
when the steel bar is strongly coupled to the connecting sleeve, a neighboring crest and root of the first internal threaded part and the second external threaded part are not in contact with each other, whereas inclined flanks of the threads of the first internal threaded part and the second external threaded part are in close contact with each other.

2. A steel bar connecting structure comprising a connecting sleeve which has a cylindrical shape, and has on an inner circumference thereof a first internal threaded part, and is inclined such that an outer diameter of the connecting sleeve is reduced from a center thereof to opposite ends thereof, with first external threaded parts provided on inclined parts of an outer circumference of the connecting sleeve, and a plurality of slits provided in the opposite ends of the connecting sleeve and extending in a longitudinal direction of the connecting sleeve, two nuts fastened to the first external threaded parts, respectively, and a steel bar having on an outer circumference thereof a second external threaded part, which engages with the first internal threaded part, wherein
a circumference of the second external threaded part of the steel bar is smaller than a circumference of the first internal threaded part provided on an inner circumference of the connecting sleeve so that the second external threaded part is not in complete contact with the first internal threaded part, and
a crest of each of threads of the first internal threaded part and the second external threaded part is cut, whereby
when the steel bar is inserted into the connecting sleeve and each of the nuts is fastened to each of the first external threaded parts provided on the outer circumference of the connecting sleeve, so that the slits become narrow and the steel bar is strongly coupled to the connecting sleeve, a neighboring crest and root of the threads of the internal threaded part and the external threaded part are not in contact with each other, and inclined flanks of the threads of the internal threaded part and the external threaded part are in close contact with each other.

3. The steel bar connecting structure according to claim 2, wherein the slits comprise four or more slits arranged radially.

4. The steel bar connecting structure according to claim 3, wherein the slits are alternately arranged on the opposite ends of the connecting sleeve, and extend from the opposite ends of the connecting sleeve through a center thereof to predetermined positions.

5. The steel bar connecting structure according to claim 4, wherein part of a thread, positioned at an end of the steel bar, is eliminated to a depth of a root, and a first end surface is provided on an end thread among the remaining threads, and a filling part having no root is provided at a center in the connecting sleeve.

6. A steel bar connecting structure, comprising:
a connecting sleeve having on an inner circumference thereof first concave parts and first convex parts at regular intervals in such a way as to be perpendicular to a longitudinal direction of the connecting sleeve; and
a steel bar inserted into the connecting sleeve, and having second concave parts and second convex parts in such a way as to be perpendicular to a longitudinal direction of the steel bar, the second concave parts and the second convex parts being coupled to the first concave parts and the first convex parts, wherein
each of the first convex parts of the connecting sleeve is not higher than a corresponding first concave part of the steel bar, and each of the first concave parts of the connecting sleeve is higher than a corresponding second convex part of the steel bar, so that when the steel bar is coupled to the connecting sleeve, apexes of the convex and concave parts of the connecting sleeve and the steel bar are in contact with each other, and inclined side surfaces of the concave and convex parts are in strong close contact with each other, when the steel bar is coupled to the connecting sleeve.

7. A steel bar connecting structure, comprising:
a connecting sleeve comprising a plurality of parts which are divided in a longitudinal direction of the connecting sleeve and are assembled with each other, thus forming a cylindrical shape, an outer circumference of the connecting sleeve being inclined such that a thickness thereof is reduced from a center of the connecting sleeve to opposite ends thereof, with first external threaded parts provided on the outer circumference of the connecting sleeve, the connecting sleeve having on an inner circumference thereof first concave parts and first convex parts at regular intervals in such a way as to be perpendicular to the longitudinal direction of the connecting sleeve;
two nuts fastened to the first external threaded parts, respectively; and
steel bars each having on an outer circumference thereof second concave parts and second convex parts in such a way as to be perpendicular to a longitudinal direction of the steel bar, the second concave parts and the second convex parts being coupled to the first concave parts and the first convex parts, wherein
when the divided parts of the connecting sleeve are positioned between the two steel bars, and the nuts are fastened to first external threaded parts, which are provided on inclined parts of the opposite ends of the connecting sleeve, the divided parts of the connecting sleeve are brought near to each other, and an inner diameter of the connecting sleeve is reduced, and since each of the first convex parts of the connecting sleeve is not higher than a corresponding first concave part of each of the steel bars, and each of the first concave parts of the connecting sleeve is higher than a corresponding second convex part of the steel bar, apexes of the concave and convex parts of the connecting sleeve and each of the steel bars are not in contact with each other, and inclined side surfaces of the concave and convex parts are in close contact with each other, when the steel bar is coupled to the connecting sleeve.

8. The steel bar connecting structure according to claim 7, wherein a stop protrusion protrudes inwards from an inner circumference of each of the divided parts of the connecting sleeve, so that when the two steel bars are inserted into the connecting sleeve, the steel bars do not pass through the center of the connecting sleeve.

9. The steel bar connecting structure according to claim 1, wherein an observation hole is provided in the center of the connecting sleeve.
